(19) United States
(12) Patent Application Publication
(10) Pub. No.: US 2015/0053140 A1
(43) Pub. Date: Feb. 26, 2015

(54) MODULARLY CONNECTED DEVICE FOR CLEANING A PET TOILET

(71) Applicant: Ju Hwan ROH, Incheon (KR)

(72) Inventor: Ju Hwan Roh, Incheon (KR)

(21) Appl. No.: 14/385,169

(22) PCT Filed: Mar. 14, 2013
(86) PCT No.: PCT/KR2013/002035

§ 371 Date: Sep. 15, 2014

(30) Foreign Application Priority Data
Mar. 15, 2012 (KR) 10-2012-0026491
Dec. 21, 2012 (KR) 10-2012-0150841

(51) Int. Cl. A01K 1/01

(52) U.S. Cl. CPC A01K 1/011; A01K 1/0114
USPC 119/163

(57) ABSTRACT

A modularly connected device for cleaning a pet toilet according to the present invention includes a water inlet module and a water outlet module detachably attached so that the device may be conveniently installed in various places to automatically clean the pet toilet by sensing the feces and urine of pets. With such a modularly connected device for cleaning a pet toilet according to the present invention, the water inlet module and water outlet module are modularly connected and detached to provide convenience and simplicity of cleaning with a high capability of sensing the feces and urine of pets.

### TECHNICAL FIELD

The present invention relates to a modularly connected device for cleaning a pet toilet, and more particularly to a cleaning device including a water supply and drainage system which automatically cleans the pet toilet after the pet defecates (urinates). In the device, a water inlet module which supplies cleaning water to the pet toilet and a water outlet module which collects the water which has cleaned the pet toilet are assembled in an attachable and detachable manner by connecting modules, and the device can be used only with the water inlet module without the water outlet module. Also, the device can be used with ease not only in a place having no drainage facility such as a room, a living room and a veranda but also in a place having the drainage facility such as a restroom. Also, the device is able to detect the pet in more detail.

### BACKGROUND DESCRIPTION

A pet should be raised indoor in consideration of sanitization. Of course, it is important to clean hairs of the hair-shedding pet, and it is the most important to designate a defecating place of the pet and to train the pet to defecate at the specific defecating place.

In the past, it was often to train the pet to defecate on the floor of the restroom. However, at present, a pet toilet with carious functions is presented and provides the convenience of cleaning.

The known pet toilet is comprised of feces receptacle and nets. After the pet is seated on the net and defecates/urinates, the owner of the pet collects the feces on the net and separately collects the urine which has gathered at the feces receptacle through the through-hole of the net.

While the feces gathered on the net are easy to collect, the urine is collected in the feces receptacle. Therefore, it is troublesome to separate the net and then to frequently clean the feces receptacle as well as the net. Further, if the cleaning is neglected, there occurs a sanitary problem of a bad smell remaining in a room.

To prevent such problems, devices having various functions for cleaning a pet toilet have been disclosed in domestic and foreign patents. In particular, in the “a module type device for cleaning a pet toilet” disclosed in Korean Patent No. 1178799 previously filed and registered by the invention applicant, a water inlet module which supplies water to the pet toilet and a water outlet module which collects the water which has cleaned the pet toilet can be installed in a prefabricated manner, so that the device provides convenience for users irrespective of a place.

According to the technology, the device provides convenience for attachable and detachable connection between the water inlet module and the water outlet module, connection and release of tubes through which water flows, and waterproofing of the tubes. Further, the device can be also installed in various places.

The device of the technology has been patented through the feature of the attachable and detachable connection between the water inlet module and the water outlet module and the waterproof tube. Particularly, only the water inlet module can be used without the water outlet module in a place having the drainage facility such as a restroom or veranda. However, according to the technology, when only the water inlet module is used without the water outlet module, the water inlet module is not stably standing-supported. Therefore, it is true that it is a little inconvenient to use independently the water inlet module.

Additionally, in determining whether or not the pet is located on the pet toilet by a sensor method, according to a sensor structure in which an one-direction transmitting sensor irradiates infrared rays toward the pet, that is, the sensor configuration in which the transmitting sensor and receiving sensor are not remotely separated, the pet with black hair absorbs the infrared rays, or errors are frequently caused in a place where bright light is irradiated like a veranda. Moreover, an ultrasonic method also causes operation errors due to the movements of surrounding people, etc.

Therefore, there is a requirement for improving the modularly connected device for cleaning a pet toilet, which has a structure capable of maintaining the modular connection between the water inlet module and the water outlet module, of strengthening the own use environment of the water inlet module when the water inlet module and the water outlet module are separated from each other, and of accurately and stably recognizing the presence of the pet, without being affected by the movements of neighboring objects the hair color of the pet and ambient light.

### DISCLOSURE

### Technical Problem

The present invention is designed to overcome the above problems. The objective of the present invention is to provide a device for cleaning a pet toilet capable of providing an automatic cleaning function of the pet toilet, of providing convenience for installation through simply attachable and detachable connection between the water inlet module which supplies cleaning water to the pet toilet and the water outlet module which collects the water which has cleaned the pet toilet and discharges the water to the outside, and of providing an environment in which the pet toilet can be stably cleaned only with the water inlet module without the water outlet module in a place having basically the drainage facility such as a restroom.

Another objective of the present invention is to provide a structure in which a transmitting sensor is disposed on one side of the pet toilet and a receiving sensor is disposed on the main body, i.e., the opposite side to the one side, that is, the front side of the water inlet module, not to be affected by the hair color of the pet, ambient light and the movements of neighboring objects, so that a transmission part and a receiving part are separated from each other and the location of the pet is recognized. Accordingly, it is possible to supply the cleaning water to the pet toilet under the state where the recognition error of the pet has been significantly reduced.

Further another objective of the present invention is to additionally provide an attachable and detachable bar which is disposed on one side the water inlet module and prevents the rotation of the supply tube, such that the attachable and detachable part which seals the supply tube is prevented from unnecessarily rotating when the water inlet module is attached to or detached from the water outlet module.

Yet another objective of the present invention is to provide a valcon valve and a control box controlling the valcon valve for the purpose of efficiently controlling the water supplied from the water inlet module to the pet toilet. As a result, it is intended that water supply is automatically and manually controlled.

Still another objective of the present invention is to provide a controller capable of supplying the cleaning water by being elastically adapted to the position change of the pet on the net.

### Technical Solution

In order to achieve the above-objectives, a modularly connected device for cleaning a pet toilet in accordance with the embodiment of the present invention includes:
a pet toilet which includes: a net on which a pet seats and defecates, and a feces receptacle which receives feces of the pet introduced from the net; a water inlet tube which introduces water stored in a water inlet module into the feces receptacle; a water outlet tube which discharges dirty water after cleaning the feces receptacle; and a transmission sensing unit on which a transmitting sensor which transmits a signal to a receiving sensor has been mounted;
a water inlet module which includes: a water tank which stores water introduced from the outside through a water tank supply tube; a supply tube which connects a supply hole of the water tank with the water inlet tube and has an openable and closable check valve installed on one side thereof; and a receiving sensor which receives the signal of the transmitting sensor;
a water outlet module which is disposed under the water inlet module and is connected to the water inlet module in an attachable and detachable manner, and which temporarily stores dirty water introduced through the water outlet tube by driving a motor; and
a controller which identifies whether the pet defecates or not through a sensing signal of the transmitting sensor and the receiving sensor, and then controls the opening and closing of the check valve.

The transmission sensing unit communicates with the controller by means of any one of a cable and a wireless communication unit, and includes: a transmitting sensor which has a plug in a lower portion thereof; and a sensor housing which is formed to protrude outwardly from an opposite side to the water inlet module and has a plug receiving hole receiving the plug. The transmitting sensor is attachably and detachably connected to the sensor housing.

### Advantageous Effects

According to the modularly connected device for cleaning a pet toilet in accordance with the embodiment of the present invention,

1) the water inlet module and the water outlet module can be attached to or detached from each other by modular connection, and the accuracy of the pet detection is improved. Also, the convenience and simplicity of cleaning can be provided.

2) Only the water inlet module can be independently used without the water outlet module, and particularly can be stably supported even on the inclined surface.

3) By means of the valcon valve, it is possible to prevent the defect of the solenoid valve and to automatically and manually control the opening and closing of the valve.

4) It is assured that a water supply tube and the water inlet tube are waterproof and are easily connected to each other in an attachable and detachable manner. Also, a rotation preventing bar prevents the water supply tube from unnecessarily rotating.

5) It is also possible to efficiently block the water overflowing due to the failure of the pump.

### DESCRIPTION OF DRAWINGS

FIG. 1 is a perspective view showing a state where a water inlet module and a water outlet module have been connected to each other in a modularly connected device for cleaning a pet toilet in accordance with an embodiment of the present invention;

FIG. 2 is a perspective plan view showing a state where the water inlet module and the water outlet module have been separated from each other in the modularly connected device for cleaning a pet toilet in accordance with the embodiment of the present invention;

FIG. 3 is a perspective view showing a bottom structure of a pet toilet;

FIG. 4 is a perspective view showing an internal configuration of a water tank of the water inlet module in a state where a cover is opened;

FIG. 5 is a perspective view schematically showing the structure of the water outlet module; and

FIG. 6 is a block diagram schematically showing a configuration of a controller of the present invention.

### BEST MODE

The best mode of the modularly connected device for cleaning a pet toilet in accordance with the present invention includes:
a pet toilet which includes: a net on which a pet seats and defecates, and a feces receptacle which receives feces of the pet introduced from the net; a water inlet tube which introduces water stored in a water inlet module into the feces receptacle; a water outlet tube which discharges dirty water after cleaning the feces receptacle; and a transmission sensing unit on which a transmitting sensor which transmits a signal to a receiving sensor has been mounted;
a water inlet module which includes: a water tank which stores water introduced from the outside through a water tank supply tube; a supply tube which connects a supply hole of the water tank with the water inlet tube and has an openable and closable check valve installed on one side thereof; and a receiving sensor which receives the signal of the transmitting sensor;
a water outlet module which is disposed under the water inlet module and is connected to the water inlet module in an attachable and detachable manner, and which temporarily stores dirty water introduced through the water outlet tube by driving a motor; and
a controller which identifies whether the pet defecates or not through a sensing signal of the transmitting sensor and the receiving sensor, and then controls the opening and closing of the check valve.

### MODE FOR INVENTION

Hereafter, an embodiment of the present invention will be described in detail with reference to the accompanying drawings. The accompanying drawings are not shown by the scale. The same reference numerals in each drawing correspond to the same elements.

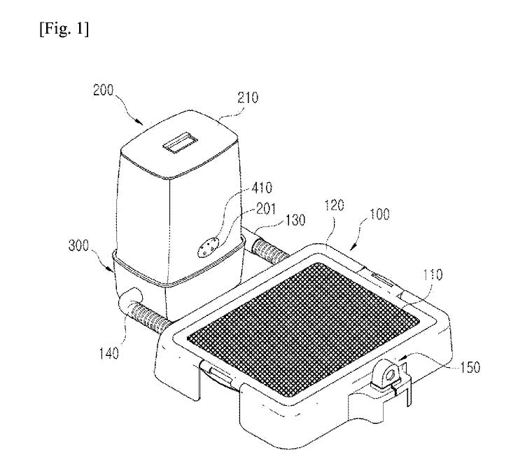

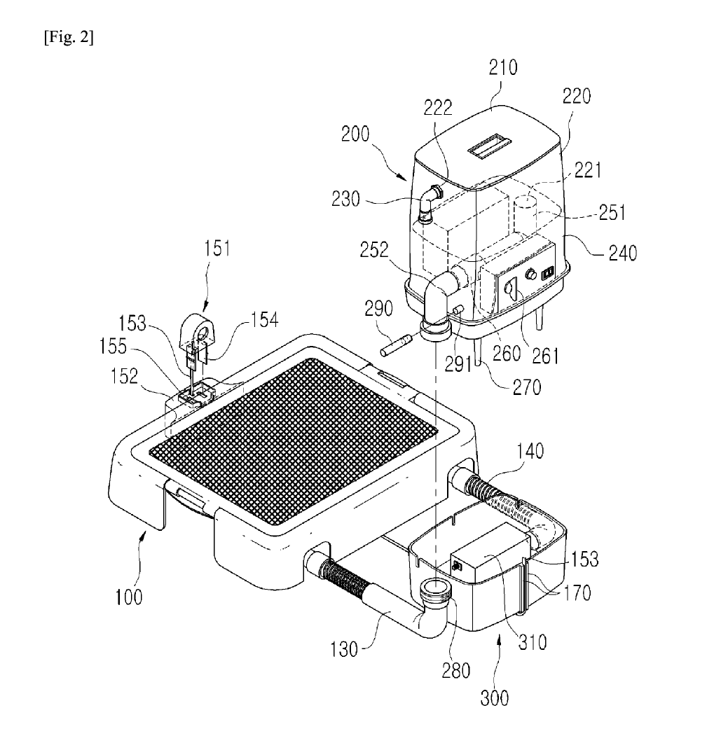

FIG. 1 is a perspective view showing a state where a water inlet module and a water outlet module have been connected to each other in a modularly connected device for cleaning a pet toilet in accordance with the embodiment of the present invention. FIG. 2 is a perspective view showing a state where the water inlet module and the water outlet module have been separated from each other in the modularly connected device for cleaning a pet toilet in accordance with the embodiment of the present invention.

As shown in FIGS. 1 and 2, the modularly connected device for cleaning a pet toilet in accordance with the embodiment of the present invention includes a pet toilet 100 which collects the feces and urine of a pet after the pet defecates/urinates landing or seating on the pet toilet 100, a water inlet module 200 which sprays cleaning water to the pet toilet 100, a water outlet module 300 which collects the water which has cleaned the pet toilet, and a controller 400 which controls the detailed functions. The water inlet module 200 and the water outlet module 300 are attachable to and detachable from each other by a connector which provides an attachable and detachable function.

Hereafter, each detailed configuration and function will be described in detail with reference to the accompanying drawings.

As shown in FIGS. 1 and 2, the pet toilet 100 of the embodiment of the present invention provides a space for receiving and storing the feces of the pet and for receiving the water of the water inlet module 200 and performing the cleaning. Specifically, the pet toilet 100 includes a net 110 where the pet defecates, a feces receptacle 120 which temporarily stores the feces of the pet, a water inlet tube 130 which receives the cleaning water from the water inlet module, a water outlet tube 140 which discharges the water to the outside or to the water outlet module after cleaning, and a transmission sensing unit 150 which transmits an object identification signal to a receiving sensor 201 of the water inlet module 200.

First, the net 110 is commonly included in the known pet toilet 100. The net 110 has a plurality of through-holes formed therein and is formed in the form of a thin panel. The net 110 is mounted on the feces receptacle 120 in an attachable and detachable manner.

That is, the net 110 provides a flat and wide space where a pet seats and defecates and has a plurality of the through-holes allowing the feces, particularly urine to be transferred to the feces receptacle 120. Furthermore, the net 110 is connected to the feces receptacle 120 in an attachable and detachable manner in order to collect or clean the feces within the feces receptacle 120.

The feces receptacle 120 functions to store the feces (mainly urine) of the pet through the through-hole of the net 110. The feces receptacle 120 is formed to have a certain volume under the net 110. The feces receptacle 120 has the water outlet tube 140 and the water inlet tube 130. The water outlet tube 140 cleans and washes by spraying the water supplied from the below-described water inlet module 200 to the inner space thereof, and then discharges the water (including urine) to the water outlet module 300. The water inlet tube 130 receives the cleaning water from the water inlet module 200.

The water inlet tube 130 functions to supply and spray the water supplied from the water inlet module 200 to the inner space of the feces receptacle 120. The end of the water inlet tube 130 may include a spray part. The spray part may be formed at any one of a side end of the pet toilet 100 in contact with a main body 200 or one side on which the pet toilet 100 contacts with the main body 200, multiple points in the lateral circumferential portion of the feces receptacle 120, the bottom portion of the feces receptacle 120, or may be formed to include above them. The spray part has a base which receives the water by being connected to the water inlet module 200 through the water inlet tube 130 regardless of the installation position.

Also, the spray part may include a spray nozzle. The spray nozzle has a preset spray direction such that the water is sprayed in a particular direction, and furthermore is able to determine the spray pressure. In other words, the spray nozzle is installed at the end through which the water which has entered the spray part is discharged outwardly. The spray nozzle controls the spray direction and the spray pressure.

The water outlet tube 140 functions as a tube through which dirty water after cleaning is discharged to the outside. The dirty water may be immediately discharged to the outside or may be discharged to the water outlet module 300 connected thereto for the purpose of a place having no drainage facility.

The transmission sensing unit 150 includes a transmitting sensor 151 which functions to irradiate an object detection signal represented by an infrared ray toward the receiving sensor 201 of the water inlet module 200. Specifically, the transmission sensing unit 150 is comprised of the transmitting sensor 151, a sensor housing 152, and a cable 153.

As shown in FIG. 2, the transmitting sensor 151 is connected to the controller (specifically, a sensor signal detection module) of the water inlet module 200 through the intermediation of the cable 153. The transmitting sensor 151 is not only controlled in a wired manner by the controller 400 through the cable 153, but also irradiates the object detection signal to the receiving sensor 201 by receiving electric power. Therefore, the transmitting sensor 151 is mounted on the sensor housing 152 in a direction toward the receiving sensor 201.

The sensor housing 152 is formed to protrude from one side of the pet toilet 100, specifically, from an opposite side to the receiving sensor 201 of the water inlet module 200 in the side direction of the pet toilet. The sensor housing 152 has a plug receiving hole 155 formed therethrough. The plug receiving hole 155 receives a plug 154 formed to protrude from the lower portion of the transmitting sensor 151. That is, the sensor housing 152 receives the transmitting sensor 151 in an attachable and detachable manner. When the plug 154 extending downward from the lower portion of the transmitting sensor 151 is inserted into the plug receiving hole 155, the transmitting sensor 151 is securely coupled to and released from the sensor housing 152.

The cable 153 functions to connect the controller (sensor signal determination module) with the transmitting sensor 151. While receiving the signal processing control of the controller (sensor signal determination module), the cable 153 not only transmits the sensor signal but also receives electric power.

Since it is expected that the cable 153 elongating from the water inlet module 200 is obstructive, the cable 153 may be formed in the form of a connection terminal, in other words, one side portion of the cable 153 may be made to be attachable and detachable. Furthermore, the cable 153 is controlled cablelessly by the controller 400 in a wireless communication manner and has an independent power supply means through the mounting of its own battery.

However, due to the unique characteristics of the device for cleaning a pet toilet, which is often covered with the water through use of the water, when the connection terminal of the cable is covered with the water, malfunction or failure is highly expected and errors are highly expected in the sensing of the wireless communication sensor. Accordingly, for the purpose of ensuring the safety from the water and improving the sensor recognition power, it is preferable, as described above, that the controller 400 and the transmitting sensor 151 are connected with each other by using the wired cable 153.

The transmission sensing unit 150 and the receiving sensor 201 form a pet position detection sensor set with the net of the pet toilet 100 placed therebetween. The transmission sensing unit 150 and the receiving sensor 201 mutually transmit and receive an object recognition signal. Compared with an object detection sensor (ultrasonic wave, etc) integrally formed without distinction of the transmission part and the receiving part, the remote configuration of the sensors is able to prevent malfunction, to excellently detect a pet with black hair absorbing the sensor light, and to accurately recognize and detect the pet without malfunction even in a facility with natural light like a veranda.

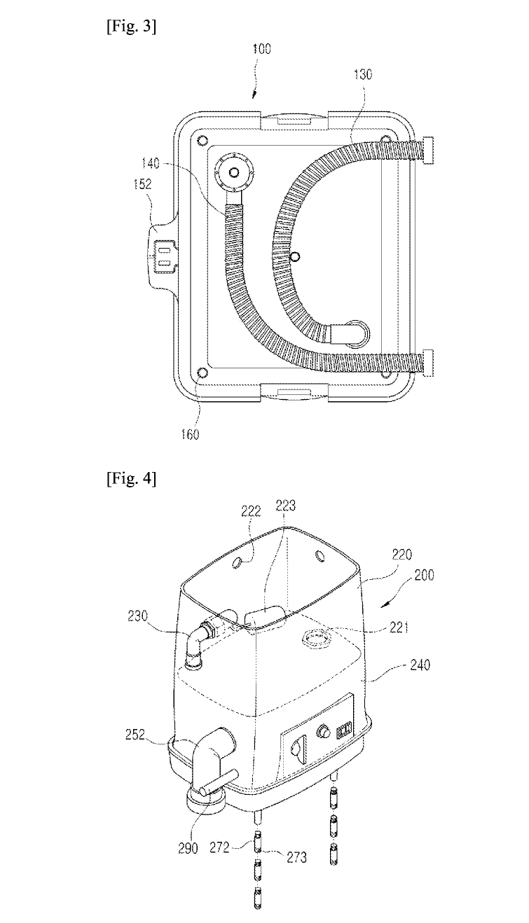

FIG. 3 is a perspective view showing a bottom structure of a pet toilet.

Referring to FIG. 3, it can be found that the pet toilet 100 is stably supported on the ground by a support leg 160, and two tubes extend in a space between the bottom surface of the pet toilet 100 and the support leg 160. It can be also found that the diameter of the tube is the same or a little less than the height of the support leg 160, so that the pet toilet 100 is prevented from coming off from the ground.

Specifically, describing the two tubes, one tube is the water inlet tube 130 which supplies the cleaning water from the water inlet module 200 to the pet toilet, and the other tube is the water outlet tube 140 which discharges the water which has cleaned the pet toilet 100 to the water outlet module 300 or to the outside.

In particular, referring to the arrangement state of such tubes of FIG. 3, the water inlet tube 130 and the water outlet tube 140 extend to have a certain length such that the water inlet tube 130 supplies water to the inside of the feces receptacle 120 through a water inlet hole formed on one side of the feces receptacle 120, and the water outlet tube 140 discharges the dirty water to the water outlet module or to the outside through a water outlet hole. It can be understood that the water inlet tube and the water outlet tube naturally extend in the form of “L” or “U” at a distance apart from the water inlet hole and the water outlet hole respectively.

This intends to prevent that, for example, when the distance between the water inlet hole and the water inlet tube 130 is short, the length of the tube is shortened and the bending degree is reduced, so that the water inlet tube 130 is obstructive to another tube, i.e., the water outlet tube 140. In other words, this intends that both of the water inlet tube 130 and the water outlet tube 140 have a sufficient length to be mounted on the bottom surface of the pet toilet 100 and are naturally bent or curved, so that both of them are not obstructive to each other and are ensured to be efficiently arranged on the bottom surface of the pet toilet.

Also, the cable 153 connected to the transmitting sensor 151 is attached to a portion from the side to the bottom of the pet toilet 100 or a boundary between the side and the bottom of the pet toilet 100 (including a below-described side wall of the water outlet module) in such a manner as to be attachable to and detachable from the pet toilet 100. As a result, a cable bracket 170 for ordering the cables is formed, so that a portion of the cable 153 can be fitted and connected to the cable bracket 170.

FIG. 4 is a perspective view showing an internal configuration of a water tank of the water inlet module in a state where a cover is opened.

As shown in FIG. 4, the water inlet module 200 has a water tank shape with an open upper portion. The open portion can be opened and closed by a cover 210. A water tank 220 which receives the cleaning water to be supplied to the pet toilet 100 is provided within the water inlet module 200. A supply hole 221 is formed in the bottom surface of the water tank 220. The supply hole 221 supplies the cleaning water to a supply tube and penetrates the bottom surface of the water tank 220.

A control housing 240 is formed in the lower portion of the water tank 220. In terms of the entire water inlet module 200, the control housing 240 is integrally formed with the water tank 220. However, the control housing 240 has a space independent of the water tank 220. A supply tube 250, a check valve 260, the controller 400, and a power supply are included in the control housing 240. The internal configuration of the control housing 240 will be described below in detail with back reference to FIG. 2.

The side wall of the upper portion of the water tank 220 has a water tank supply hole 222 formed therethrough. A water tank supply tube 230 is connected to the water tank supply hole 222 and supplies water to the water tank from the outside. Particularly, the water tank supply hole 222 is respectively formed in four side walls (since the water tank generally has a rectangular shape, four side walls are provided).

This intends to allow the cleaning device of the present invention to be freely disposed in an indoor space. That is, the water tank supply hole 222 extending in various directions is connected to the cleaning device of the present invention, so that it is convenient to select a place to install the cleaning device of the present invention.

For example, when the water inlet module 200 is attached to a wall, the water tank supply tube 230 is allowed to be connected to the water tank supply hole 222 formed in right or left side wall, and then the remaining unused water tank supply holes 222 are blocked by a stopper.

That is, the water tank supply tube 230 is connected to the inside of the water tank 220 through the water tank supply hole 222. A water quantity control air bladder 223 may be connected to the inside of the water tank supply tube 230 in an attachable and detachable manner.

The water quantity control air bladder 223 rises in correspondence with the water level of the water tank 220, so that the water tank supply tube 230 becomes inclined. Therefore, when sufficient water is supplied to the water tank 220, the water is intended not to be supplied to the water tank 220 any more through the water tank supply tube 230, so that the water is prevented from overflowing. In other words, the water tank supply tube 230 becomes inclined, thereby preventing the water from being oversupplied to the water tank 220.

The water quantity control air bladder 223 may be connected to the water tank supply tube 230 in an attachable and detachable manner through a screw thread formed inside the water tank supply tube 230. It is possible that an auxiliary connecting means such as a packing/bracket is additionally added in order to prevent water leakage.

Furthermore, the receiving sensor 201 is disposed on one side of the water inlet module 200, that is, one side of the surface facing toward the pet toilet 100 (or a below-described control panel).

The receiving sensor 201, as described above, functions to receive the signal from the transmitting sensor 151. Depending on whether or not the receiving sensor 201 receives the signal of the transmitting sensor 151, it is possible to detect whether the object between the transmitting sensor 151 and the receiving sensor 201, i.e., the pet is present or not.

As such, the transmitting sensor 151 and the receiving sensor 201 function as an object recognition/detection sensor with being remotely separated from each other. Accordingly, it is possible to detect more precisely and in more detail the pet on the net than a known one direction signal transmitting sensor.

The supply tube 250 included within the control housing 260 of the water inlet module 200 supplies the cleaning water introduced through the supply hole 221 of the water tank 220 to the pet toilet through the water inlet tube 130 of the pet toilet 100. According to the driving state of the check valve 260, the supply tube 250 is able to block the flow of the water which is introduced into the pet toilet 100, such that the quantity of the water supplied to the pet toilet through the check valve 260 is controlled.

That is, the cleaning device according to the embodiment of the present invention has a structure in which the supply hole 221 is in an open state without a known flush valve mounted on the water tank of the toilet stool, and then the quantity of the water supplied to the pet toilet is controlled by controlling the opening and closing of the supply tube 260 connected to the supply hole 221 through the check value 260. Therefore, compared with an electronic control structure, the structure of the cleaning device according to the embodiment of the present invention is capable of preventing malfunction and controlling the water quantity in virtue of a simpler and more intuitive mechanical structure thereof.

The check valve 260 is mounted on one side of the inside of the supply tube 250 and controls the water flow by opening and closing the supply tube 250. There are currently released and available various check valves. In the embodiment of the present invention, a valcon valve is taken as an example of the check valve.

The valcon valve is mounted in the control housing in a state where a switch is exposed to one side (rear side) of the water inlet module 200. The valcon valve controls the opening and closing of the supply tube. While the valcon valve can be controlled by the below-described controller, the valcon valve is convenient to manually control.

Also, the known solenoid valve generates unnecessary noise while being driven, so that it is difficult for the pet to approach the net 110. However, the valcon valve is stably driven without noise.

In other words, the valcon valve can be automatically opened and closed by a check valve control module of the below-described controller 400. Furthermore, a switch 261 allowing a user to quickly open and close the supply tube 250 in an emergency situation (situation where water overflows from the pet toilet or the water outlet module) is formed on one side of the rear of the water inlet module 200, so that the supply tube 250 can be immediately closed by the operation of the switch 261.

Furthermore, the check valve 260 using the valcon valve may separately include an open switch which has an opening function as well as the closing function. In this case, the open switch also has a delay function to control the opening and closing time of the valve such that the valve is opened and then is closed in a certain period of time (for example, 20 to 30 seconds) by the operation of the open switch.

Due to the valcon valve, the check valve is automatically controlled by the controller 400, but also is quickly manually controlled (the opening and closing of the valve) in an emergency situation.

Referring to FIG. 2, it can be seen that the supply tube 250 extending and being exposed outward from the side wall of the water inlet module 200 is connected to the water inlet tube 130 of the pet toilet 100 in an attachable and detachable manner.

That is, a connector like a screw thread is formed on the connection portion between the supply tube 250 and the water inlet tube 130, and thus, the supply tube 250 and the water inlet tube 130 are connected in an attachable and detachable manner through the attachable and detachable connection of the connector (screw thread connection). A sealing process can be performed on the connector by a connection auxiliary, i.e., an auxiliary connecting means such as a packing or bracket.

Furthermore, the supply tube 250 including the portion thereof extending outward from the control housing 240 may be formed as a single unit. However, in order to ensure the free rotation of the outwardly exposed portion of the supply tube, a first supply tube 251 disposed within the control housing 240 is freely rotationally connected to an outwardly exposed second supply tube 252 by a mechanical connecting means like a bearing, and thus, it is preferable to ultimately obtain the free rotation of the second supply tube 252 from the viewpoint of intending a convenient attachable and detachable relationship between the supply tube 250 and the water inlet tube 130.

Legs 270 are formed on the bottom surface of the water inlet module 200. Accordingly, the water inlet module 200 can be independently supported on the ground in an installation condition which does not require the water outlet module 300.

That is, when the cleaning device according to the embodiment of the present invention is installed in a place having the drainage facility such as a restroom, the water outlet tube 140 of the pet toilet is directly pushed and fixed to the water outlet hole of the restroom, and then the dirty water after the cleaning can be discharged to the outside without receiving the dirty water in the water outlet module 300. Here, the leg 270 of the water inlet module 200 functions to stably support the water inlet module.

The leg 270 of the water inlet module 200 may be, as shown in FIGS. 1 and 2, formed as a single unit, and may also be, as shown in FIG. 4, formed to be adjusted in length.

Specifically, the leg 270 of FIG. 4 has a prefabricated structure of a plurality of leg sections 271. The leg section 271 has a connection piece 272 formed on one end thereof or on both ends thereof, and the leg sections 271 are connected to each other. The leg sections 271 may have the same length as each other or may have different lengths from each other.

Due to the leg section 271, the length of each of the legs 270 can be independently adjusted. That is, in the cleaning device according to the embodiment of the present invention, it is desirable to cause the water inlet module 200 to be in a horizontal state for the purpose of the smooth operations of the described water quantity control air bladder 223 and other components. However, depending on situations, the cleaning device according to the embodiment of the present invention may be disposed on an installation place having an inclined bottom. Therefore, it is possible to cause the cleaning device according to the embodiment of the present invention to be elastically maintained in a horizontal state by controlling the number of the used leg sections 271 and by selecting the leg sections 271 having different lengths from each other.

As shown again in FIG. 2, the outwardly exposed supply tube (the second supply tube 252) may be connected to the water inlet tube 130 through the intermediation of a connection auxiliary 280, and for convenience of cleaning and assembly and disassembly, is attachable and detachable by the screw thread. Particularly, as described above, the outwardly exposed supply tube (the second supply tube) is freely rotated in order to ensure the convenient connectivity between the second supply tube 252 and the water inlet tube 130.

However, when the outwardly exposed supply tube (the second supply tube) is rotated by an external force or by mistake, the tight connection between the outwardly exposed supply tube (the second supply tube 252) and the water inlet tube 130 is interrupted. Therefore, even though the connection auxiliary is added, there is a possibility that the water leaks out between the outwardly exposed supply tube (the second supply tube 252) and the water inlet tube 130.

In order to prevent such a problem, as shown in FIG. 2, a rotation preventing bar 290 may be formed on one side of the water inlet module 200 (within a radius of rotation of the second supply tube).

Specifically, a bar receiving groove 291 is formed in the water inlet module within the radius of rotation of the outwardly exposed supply tube (the second supply tube), and then the rotation preventing bar 290 is fitted and connected to the bar receiving groove 291 in an attachable and detachable manner. Here, the screw thread is formed on the inner circumferential surface of the bar receiving groove 291 and the outer circumferential surface of the rotation preventing bar 290, and then both may be connected to each other in a screw-thread connection method.

The rotation preventing bar 290 prevents that the water inlet tube 130 is not tightly connected to the outwardly exposed supply tube (the second supply tube) by the unnecessary rotation of the outwardly exposed supply tube (the second supply tube). When the cleaning device is normally used, the rotation preventing bar 290 is fitted and connected to the bar receiving groove 291, thereby preventing the rotation of the outwardly exposed supply tube (the second supply tube). When the outwardly exposed supply tube is intended to be rotated for cleaning, the rotation preventing bar 290 is separated from the bar receiving groove 291, thereby rotating the supply tube.

Due to the rotation preventing bar 290, it is possible to ensure that the outwardly exposed supply tube (the second supply tube) is safely and conveniently connected to the water inlet tube 130.

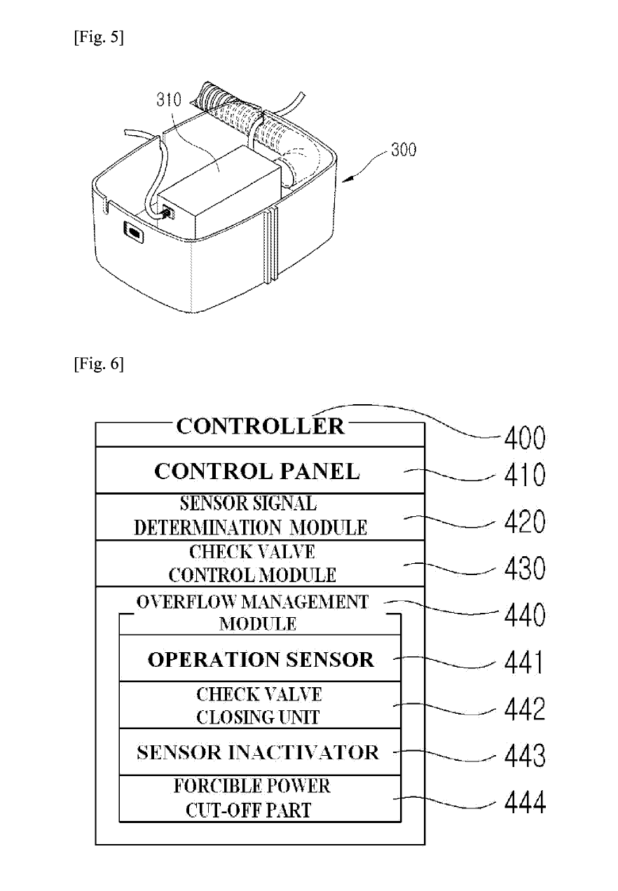

FIG. 5 is a perspective view schematically showing the structure of the water outlet module.

The water outlet module 300 according to the embodiment of the present invention is disposed under the water inlet module 200 and is connected to the water inlet module 200 in an attachable and detachable manner. Generally, the lower portion of the water inlet module 200 may be received in the water outlet module 300, and the water inlet module 200 and the water outlet module 300 may be connected to each other by a module connector formed the connection portion between the water inlet module 200 and the water outlet module 300.

Known various connecting means can be used as the module connector. The module connector includes an additional locking means and ensures strong connection of the connection portion between the water inlet module 200 and the water outlet module 300 by an external force.

The dirty water which has cleaned the pet toilet 100 is temporarily stored in the water outlet module 300 through the water outlet tube 140, and when cleaning, the user is allowed to discard the dirty water stored in the water outlet module 300. The water outlet module 300 includes a pump 310 and introduces the dirty water of the pet toilet 100 to the water outlet module 300 by means of the driving force of the pump.

Additionally, the cable bracket 170 receiving the cable 153 is provided on the outer wall of the water outlet module 300. Accordingly, the cable 153 extending from the transmitting sensor 151 is clearly ordered.

Furthermore, a threshold level line is formed within the water outlet module 300, and water level sensing modules are disposed around the threshold level line. Here, when the water is filled up to the threshold level line, the controller 400 may have a function to block the opening of the check valve 260.

FIG. 6 is a block diagram schematically showing a configuration of a controller of the present invention.

The controller 400 according to the embodiment of the present invention is mounted on either the water inlet module or the water outlet module (preferably, the control housing of the water inlet module). The controller 400 identifies whether the pet is on the net or not and then controls the opening and closing of the check valve 260 (the valcon valve is taken as an example of the check valve in the present invention) installed in the supply tube 250 of the water inlet module 200. Simultaneously with this, the controller 400 controls a time period required for supplying the water from the water inlet module 200 to the pet toilet 100 and controls an outgoing transmission signal of the transmitting sensor 151.

Specifically, the controller 400 includes basically a control panel 410, a sensor signal identification module 420, and a check valve opening/closing control module 430. Additionally, the controller 400 may include an overflow management module 440.

The control panel 410 is disposed on the front side of the water inlet module 200, i.e., the portion where the receiving sensor 201 has been disposed. The control panel 410 may include the receiving sensor 201 as well as a plurality of lamps (LED lamps) 411 and an input key 412 (switch, keyboard, button, etc).

Through the color or flicker of the lamp 411, the control panel 410 displays whether the check valve is normally operated or not. Also, through the input key 412, the control panel 410 allows the user to manually set the driving state of the check valve 260 or to select an automatic mode.

The sensor signal identification module 420 receiving the detection signal through the sensing of the sensing unit, that is, the transmitting sensor 151 and the receiving sensor 201, and then determines whether or not the pet defecates on the cleaning device itself according to the embodiment of the present invention or around the cleaning device.

As described above, particularly, the sensing unit according to the embodiment of the present invention determines whether or not the pet is located on the pet toilet 100 through the sensing of the receiving sensor 201 disposed on the front side of the water inlet module 200 and the transmitting sensor 151 disposed on one side of the pet toilet 100.

That is, when the signal transmitted from the transmitting sensor 151 is received by the receiving sensor 201, it is determined that the pet is not located on the pet toilet 100, namely, on the net 110. When the signal transmitted from the transmitting sensor 151 is not received by the receiving sensor 201, it is determined that the pet is located on the pet toilet 100.

In other words, the sensor signal identification module 420 according to the embodiment of the present invention determines whether or not the pet is located on the pet toilet 100 through the sensing of the transmitting sensor 151 and the receiving sensor 201.

When the sensor signal identification module 420 determines whether or not the pet is located on the pet toilet 100, the check valve control module 430 opens the check valve 260 in a certain period of time or immediately depending on either the check function of a separately provided timer or the check valve's (valcon valve's) own time delay function, so that the water is supplied to the inside of the feces receptacle 120 through the supply tube 250 and the water inlet tube 130.

For example, the check valve control module 430 provides the following multiple setting modes and allows the user to select any one of them. Furthermore, the user is allowed to control the delay time and the water quantity by operating the input key of the control panel 420.

A first setting mode is as follows. After the sensing unit detects continuously the pet's presence for 2 seconds, the check valve 260 is opened immediately in 5 seconds after the pet withdraws from the pet toilet 100, and is automatically closed after 20 seconds.

A second setting mode is the same as the first setting mode, with the difference being that when the sensing unit detects again the pet even for 1 second (when the pet is located again on the pet toilet) after sensing the pet, after 20 seconds from then on, the check valve 260 begins to open.

The first and second setting modes can be set according to user's operation of the input key 412 of the control panel 410.

In addition to the above examples of the setting mode, a variety of setting modes can be already stored in a separate storage means (like a memory) included in the controller 400. Also, it is possible to allow the user to control the delay time and the check valve opening time.

The overflow management module 440 functions to prevent that the dirty water of the pet toilet 100 is not discharged to the water outlet module 300 because of the failure of the pump 310 installed in the water outlet module 300, and the like, and to prevent the water from overflowing from the pet toilet 100 or the water inlet module 200. Specifically, the overflow management module 440 is comprised of an operation sensor 441, a check valve closing unit 442, a sensor inactivator 443, and a forcible power cut-off part 444.

The operation sensor 441 is disposed on one side of the inside of either the feces receptacle of the pet toilet 100 or the water inlet module 200, on the inside of the water outlet tube 140, or around the pump 310. The operation sensor 441 may be comprised of any one of a water level sensor, a flow sensor and a vibration sensor.

That is, when the operation sensor 441 is comprised of the water level sensor, the operation sensor 441 is able to measure whether or not the water exceeds the water level at a particular position of the inside of the feces receptacle 120 or the water outlet module 300. When the operation sensor 441 is comprised of the flow sensor, the operation sensor 441 is able to determine whether the flow of the water inlet tube 130 is detected or not. When the operation sensor 441 is comprised of the vibration sensor, the operation sensor 441 is able to detect whether the pump is normally operated by the vibration of the pump 310 or not.

The operation sensor 441 ultimately determines whether the water is normally discharged from the pet toilet 100 or the water outlet module 300 by the above-described determination. When the operation sensor 441 determines that the water is not normally discharged, it functions to generate an abnormal signal.

The check valve closing unit 442 functions to close the check valve 260 when it receives the abnormal signal generated from the operation sensor 441. The sensor inactivator 443 switches off, in other words, inactivates the operations of the transmitting sensor 151 and the receiving sensor 201, so that the sensing unit is not operated. That is, the sensor inactivator 443 forcibly blocks the operation of the sensing unit, so that there is no standby mode or a detection mode to open the check valve 260, even when the pet is located on the net 110.

The forcible power cut-off part 444 cuts off electric power supplied to the check valve 260 and the sensing unit such that the check valve 260 is not electronically opened and the sensing unit is not operated. In other that the check valve 260 and the sensing unit are normally operated, the forcible power cut-off part 444 requires a power separation delay time when a power cord should be unplugged and connected in a certain period of time.

Through the overflow management module 440, it is possible to provide a safe countermeasure for the failure of the pump and at least to prevent the water overflowing even if the cleaning is not normally performed.

As described above, although the structure and operation of the modularly connected device for cleaning a pet toilet have been described and shown in the drawings in accordance with the embodiment of the present invention, this is only an example. The spirit of the present invention is not limited to the above description and drawings, and can be variously modified and changed without departing from the spirit of the present invention.

### INDUSTRIAL APPLICABILITY

Since the device of the embodiment of the present invention is massively producible and has demanders for the device, it has industrial applicability.

What is claimed is:

1. A modularly connected device for cleaning a pet toilet, the device comprising:
a pet toilet which comprises:
a net which a plurality of through-holes formed therein and on which a pet seats and defecates;
a feces receptacle which supports the net and receives feces of the pet;
a spray part which is formed on any one of a side, a bottom and a circumferential portion of the feces receptacle and cleans the feces receptacle by spraying water to an inner space of the feces receptacle; and
a discharge tube which discharges dirty water after the cleaning;
a body which comprises:
a water inlet module which receives water from the outside and supplies the water through the intermediation of a supply tube connected to the spray part, and comprises a check valve that is openably and closably installed on a bottom surface thereof and introduces the water to the supply tube when it is opened;
a water outlet module which receives the dirty water discharged through the discharge tube, seats the water inlet module in a space within a step formed to protrude along an upper circumference thereof, and discards the dirty water to the outside by opening a cover disposed on an upper portion thereof; and
a sensing unit which is comprised of a position detection sensor which is formed on one side of the water inlet module and detects whether the pet approaches the pet toilet or not; and
a controller which identifies whether the pet defecates or not through a sensing signal of the sensing unit, and then controls the opening and closing of the check valve,
wherein the supply tube is attachably and detachably comprised of a first supply and a second supply tube which have different diameters from each other,
and wherein, when the first and second supply tubes are connected, the first and second supply tubes are sealed by a sealing part.

2. A modularly connected device for cleaning a pet toilet, the device comprising:
a pet toilet which comprises:
a net on which a pet seats and defecates, and a feces receptacle which receives feces of the pet introduced from the net;
a water inlet tube which introduces water stored in a water inlet module into the feces receptacle;
a water outlet tube which discharges dirty water after cleaning the feces receptacle; and
a transmission sensing unit on which a transmitting sensor which transmits a signal to a receiving sensor has been mounted;
a water inlet module which comprises:
a water tank which stores water introduced from the outside through a water tank supply tube;
a supply tube which connects a supply hole of the water tank with the water inlet tube and has an openable and closable check valve installed on one side thereof; and
a receiving sensor which receives the signal of the transmitting sensor;
a water outlet module which is disposed under the water inlet module and is connected to the water inlet module in an attachable and detachable manner, and which temporarily stores dirty water introduced through the water outlet tube by driving a motor; and
a controller which identifies whether the pet defecates or not through a sensing signal of the transmitting sensor and the receiving sensor, and then controls the opening and closing of the check valve,
wherein the water inlet module has a leg formed on a bottom surface thereof.

3. The modularly connected device for cleaning a pet toilet of claim 2, wherein the transmission sensing unit communicates with the controller by means of any one of a cable and a wireless communication unit, and comprises:
a transmitting sensor which has a plug in a lower portion thereof; and
a sensor housing which is formed to protrude outwardly from an opposite side to the water inlet module and has a plug receiving hole receiving the plug,
wherein the transmitting sensor is attachably and detachably connected to the sensor housing.

4. The modularly connected device for cleaning a pet toilet of claim 2, wherein the leg comprises a plurality of leg sections which are attachable and detachable through the intermediation of a connector.

5. The modularly connected device for cleaning a pet toilet of claim 2, wherein the water inlet module further comprises a control housing which is formed in a lower portion of the water tank and has a space independent of the water tank, and wherein the supply tube is connected to the supply hole and is received in the control housing.

6. The modularly connected device for cleaning a pet toilet of claim 2, wherein the check valve is comprised of a valcon valve and is manually controlled to be opened and closed by operating a switch provided on a side of the water inlet module.

7. The modularly connected device for cleaning a pet toilet of claim 5, wherein the supply tube is comprised of a first supply tube received within the control housing and a second supply tube which is rotatably connected to the first supply tube, extends and is exposed outward from the water inlet module, and is connected to the water inlet tube, and wherein a screw thread is formed on a connection portion between the second supply tube and the water inlet tube, so that the second supply tube and the water inlet tube are screw-thread connected to each other in an attachable and detachable manner.

8. The modularly connected device for cleaning a pet toilet of claim 7, wherein a rotation preventing bar is further provided on one side of the water inlet module within a radius of rotation of the second supply tube, and wherein the rotation preventing bar is connected to a bar receiving groove in an attachable and detachable manner in such a manner as to prevent the second supply tube from rotating.

9. The modularly connected device for cleaning a pet toilet of claim 2, wherein the controller further comprises an overflow management module which is comprised of an operation sensor which detects whether a pump within the water outlet module is normally operated or not, a check valve closing unit which closes the check valve when it receives an abnormal signal generated from the operation sensor, and a forcible power cut-off part which forcibly cuts off electric power supplied to the transmitting sensor and the receiving sensor.
